(19) United States
(12) Patent Application Publication
(10) Pub. No.: US 2025/0231055 A1
(43) Pub. Date: Jul. 17, 2025

(54) OPTIMIZATION METHOD BASED ON MEASUREMENT DATA OF ULTRASONIC GAS METER

(71) Applicant: ZENNER METERING TECHNOLOGY(SHANGHAI) LTD., Shanghai (CN)

(72) Inventors: Ronghua XU, Shanghai (CN); Haijun REN, Shanghai (CN); Hongjun CHEN, Shanghai (CN); Shihua LI, Shanghai (CN); Wenjun WANG, Shanghai (CN)

(73) Assignee: ZENNER METERING TECHNOLOGY(SHANGHAI) LTD., Shanghai (CN)

(21) Appl. No.: 18/909,848

(22) Filed: Oct. 8, 2024

(30) Foreign Application Priority Data
Jan. 15, 2024 (CN) 2024100528622

(51) Int. Cl. G01F 1/66

(52) U.S. Cl. CPC G01F 1/66

(57) ABSTRACT

An optimization method based on measurement data of an ultrasonic gas meter, includes: if a relative strength index obtained by analysis does not meet expectation, calculating the degree of influence of a measurement condition on the relative strength index and determining whether to compensate the measurement data of the gas meter according to magnitude of the degree of influence; constructing an initial compensation model for the measurement data of the gas meter; performing sensitivity analysis on the optimized compensation model after multi-variable optimization; completing the correction of display data of the gas meter by a compensation factor combined with real-time temperature and pressure data and obtaining fluid features in a pipeline; matching the gas meter with the corresponding optimization plan from the pre-constructed gas meter optimization knowledge graph based on the correspondence between the fluid features and an optimization plan; and executing the optimization plan to optimize the gas meter.

### INCORPORATION BY REFERENCE

This application claims priority to China Patent Application No. 2024100528622, filed Jan. 15, 2024, the contents of which are hereby incorporated by reference in their entirety.

### TECHNICAL FIELD

The present disclosure relates to the technical field of measurement data optimization, and particularly, to an optimization method based on measurement data of an ultrasonic gas meter.

### BACKGROUND

An ultrasonic gas meter is a gas meter that uses ultrasonic technology for measurement. Compared with traditional mechanical gas meters, the ultrasonic gas meter has higher measurement accuracy and reliability, and is not easily affected by factors such as mechanical wear and aging. The working principle of the ultrasonic gas meter is to measure the gas flow rate by using the relationship between the propagating speed of ultrasonic waves in the gas and the gas flow rate. When the gas passes through the ultrasonic gas meter, an ultrasonic transmitter emits a beam of ultrasonic waves that propagates in the gas. When encountering obstacles in the gas (such as impurities or gas molecules in the gas), the ultrasonic waves will be reflected and scattered. By measuring the time and speed of ultrasonic waves propagating in the gas, the flow rate of the gas may be calculated.

In the Chinese invention patent application with publication number CN116295692A, a gas data processing method, system, and device for a membrane gas meter, and a medium are disclosed. This compensation method includes: obtaining a character length and a character interval length of the diaphragm gas meter, and determining a character center angle and a character interval center angle of the diaphragm gas meter according to the character length and the character interval length; obtaining a rotation volume of the diaphragm gas meter, and determining a character interval compensation amount of the diaphragm gas meter according to the rotation volume and the character interval central angle; determining measurement time and a wheel diameter of the diaphragm gas meter; obtaining boundary information and a boundary distance of the diaphragm gas meter according to the measurement time; and determining a compensated gas amount of the diaphragm gas meter according to the character interval compensation amount, the character wheel diameter, the rotation volume, and the boundary distance.

The above compensation method may accurately measure the gas compensation amount of the diaphragm gas meter at the beginning or end, improving the accuracy of gas measurement. However, in addition to this, in existing optimization methods of measurement data, when the ultrasonic gas meter continuously outputs display data outwards, data quality is usually used as a starting point for optimization, and when the outputted display data is abnormal, the generated abnormal data is replaced or corrected to finally obtain the corrected display data.

However, although this method of optimizing data may reduce the frequency of abnormal data, its actual coverage is narrow, and it may only screen out several abnormal points. When there are many abnormal points, they are usually solved by alarming, and, when the temperature and air pressure of the ultrasonic gas meter change, the gas state in the pipeline will also be affected. The temperature and air pressure changes will not cause enough interference to the display data of the gas meter, and the interfered display data will be difficultly determined as the abnormal data, which, thus, makes it difficult for existing optimization methods to play a practical role.

To this end, the present disclosure provides an optimization method based on measurement data of an ultrasonic gas meter.

### SUMMARY

### (1) Technical Problems Solved

In view of the shortcomings in the prior art, the present disclosure provides an optimization method based on measurement data of an ultrasonic gas meter. The optimization method includes: calculating the degree of influence of a measurement condition on the relative strength index and determining whether it is necessary to compensate the measurement data of the gas meter according to the magnitude of the degree of influence; constructing an initial compensation model for the measurement data of the gas meter; performing sensitivity analysis on the optimized compensation model after multi-variable optimization; completing the correction of display data of the gas meter by a compensation factor combined with real-time temperature and pressure data and obtaining fluid features in a pipeline; matching the gas meter with the corresponding optimization plan from the pre-constructed gas meter optimization knowledge graph based on the correspondence between the fluid features and an optimization plan; and executing the optimization plan to optimize the gas meter. The optimization method may eliminate the interference caused by temperature and pressure, reduce the measurement error of the gas meter, and improve the authenticity and reliability of the display data of the gas meter, thereby solving the technical problems recorded in the background art.

### (2) Technical Solutions

In order to achieve the above objectives, the present disclosure is implemented through the following technical solutions: An optimization method based on measurement data of an ultrasonic gas meter, including:
obtaining measurement condition data of the gas meter in a pipeline communicated with the gas meter, constructing a measurement condition set of the gas meter, and generating a condition coefficient Wp(t,u) from the measurement condition set, where if the condition coefficient Wp(t,u) exceeds a condition threshold, an early warning instruction is sent;
upon receiving the early warning instruction, performing a trend analysis on a display error of the gas meter; if the relative strength index obtained from the analysis does not meet expectation, calculating the degree of influence of a measurement condition on the relative strength index, and determining whether it is necessary to compensate the measurement data of the gas meter according to the magnitude of the degree of influence;
constructing an initial compensation model for the measurement data of the gas meter; performing a sensitivity analysis on the optimized compensation model after multi-variable optimization, and determining corresponding compensation factors according to an analysis result; and completing optimization of the display data of the gas meter by a compensation factor combined with real-time temperature and pressure data; and
if the corrected display data of the gas meter is not as accurate as expected, obtaining the fluid features in the pipeline, matching the gas meter with the corresponding optimization plan from a pre-constructed gas meter optimization knowledge graph according to the correspondence between the fluid features and the optimization plan, and executing the optimization plan to optimize the gas meter.

Further, a monitoring point is set up in the pipeline connected thereto, and in each monitoring cycle, the temperature and pressure in the pipeline are monitored to respectively obtain the measured temperature Ct and the measured pressure Cu when the gas meter works; and after several consecutive monitoring cycles, the data obtained by monitoring are summarized to construct a measurement condition set for the gas meter.

Further, the condition coefficient Wp(t,u) is obtained as follows: linear normalization is performed on the measured temperature Ct and the measured pressure Cu, and the corresponding data values are mapped in the interval, and then, based on the following formula:

$$Wp ( t , u ) = α * \frac{C {t}_{i} ( n - 1 )}{{\sum }_{i = 1}^{n} {( C {t}_{i} - \overline{Ct} )}^{2}} + β * \frac{C {u}_{i} ( n - 1 )}{{\sum }_{i = 1}^{n} {( C {u}_{i} - \overline{Cu} )}^{2}}$$

where C̅t̅ is an average value of the measured temperature in each monitoring cycle, and C̅u̅ is an average value of the measured pressure in the monitoring cycle; a weight coefficient is as follows: 0≤β0≤1, 0≤α≤1, and α+β=1, where i=1, 2, . . . n, n is the number in the monitoring cycle, which is a positive integer greater than 1.

Further, the actual gas consumption is monitored in each monitoring cycle to obtain the measurement data, and an error set is constructed after several display errors are obtained continuously by taking a difference between the measurement data and the display data of the gas meter as the display error; a trend analysis is performed on the display errors within the error set, corresponding relative strength indexes are obtained, and whether the relative strength index in the current monitoring cycle falls within a preset interval is determined, if not, a judgment instruction is sent.

Further, upon receiving the judgment instruction, the relative strength indexes and the corresponding condition coefficient Wp(t,u) in multiple monitoring cycles are continuously obtained, and linear regression analysis is performed by taking the measurement condition data corresponding to the condition coefficient Wp(t,u) as an independent variable and the relative strength index in each monitoring cycle as a dependent variable, and the corresponding regression equation is obtained.

Further, the regression coefficient corresponding to the measurement condition data in the regression equation is used as an influence factor, and then an influence coefficient Yr(t,u) is constructed as follows:

$$\{ \begin{matrix}Yr ( t , u ) = {\partial }_{1}^{t} * {ψ}_{1} + {\partial }_{2}^{u} * {ψ}_{2} \\ {ψ}_{1} + {ψ}_{2} = 1\end{matrix}$$

where ∂₁^{t} is the influence factor of the measured temperature C̅t̅, ∂₂^{u} is the influence factor of the measured pressure Cu; weight coefficients are as follows: 0≤ψ₁≤1, 0≤ψ₂ 1, and the weight coefficients can be obtained by referring to an analytic hierarchy process; and
if the influence coefficient Yr(t,u) exceeds an influence threshold, a correction instruction is sent to the outside; and if the influence coefficient Yr(t,u) does not exceed expectation, a reminder instruction is sent.

Further, a gas flow is measured at different temperatures and pressures to complete data collection; according to a gas state equation, the influence of temperature and pressure on the density of gas is analyzed, the degree of influence of a propagation speed of ultrasonic waves in gas is determined by temperature and pressure, and the corresponding physical connection is obtained; and according to the collected data and the physical connection, an initial compensation model is constructed based on an empirical nonlinear equation to describe the influence of the temperature and pressure on the measurement data.

Further, standard test data is obtained, model parameters of the initial compensation model are optimized by using multiple linear regression analysis to make the values predicted by the model fit test data, multi-variable optimization and verification of the initial compensation model are performed by using other variables, and the optimized compensation model is obtained;
a sensitivity analysis is performed on the optimized compensation model, and the degree of influence of the analysis factors on the measurement data is obtained by taking the temperature and pressure as analysis factors. The corresponding compensation factor is determined by the degree of influence. The display data of the gas meter is dynamically adjusted by the compensation factor combined with real-time temperature and pressure data.

Further, a data accuracy model is constructed by taking the measured data as the display data of the gas meter to respectively calculate the data accuracy of the display data of the gas meter before and after correction, with reference to the following way:

$$P y = \frac{1}{3} * max \vert {Yo}_{i} - \overline{Yo} \vert + \frac{2}{3} * \sqrt[3]{\frac{1}{n} * {\sum }_{i = 1}^{n - 1} {\vert {Yo}_{i} - \overline{Yo} \vert}^{3}}$$

where Yoᵢ is a value of the display data of the gas meter at a position i, and Y̅o̅ is an average value of the display data of the gas meter;
by taking the ratio of the data accuracy Py before and after compensation as an accuracy ratio Pb, if the accuracy ratio Pb exceeds a proportion threshold, a self-inspection instruction is sent to the outside.

Further, upon receiving the self-inspection instruction, collecting corresponding fluid data in the pipeline, according to the fluid data and its distribution status, a fluid data set after summarizing the fluid data is constructed, after a feature standard is set, feature identification is performed on the data in the fluid data set to obtain corresponding fluid features; and an initial knowledge graph is constructed and obtained after training and optimization and the same is used as a gas meter optimization knowledge graph by taking ultrasonic gas meter optimization as a target word.

### (3) Beneficial Effects

The present disclosure provides an optimization method based on measurement data of an ultrasonic gas meter, which has the following beneficial effects:

1. By constructing the condition coefficient Wp(t,u) a preliminary judgment is made on the degree of interference suffered by the gas meter according to the condition coefficient Wp(t,u) If the degree of interference is large, the authenticity of the display data of the gas meter is low. Through the change of the condition coefficient Wp(t,u) the working state of the gas meter can be predicted.

2. Through trend analysis, the relative strength index is used to analyze the change degree of the display error, so as to judge whether the errors generated by the gas meter will accumulate after long-term use, and then determine whether it is necessary to overhaul the gas meter according to the judgment result. If it meets the overhaul standard, the use of the gas meter can be suspended and the gas meter enters the overhaul state.

3. The degree of influence of the measurement condition of the gas meter on its display error change trend is determined according to the value of the influence coefficient Yr(t,u) If the degree of influence is relatively large, a correction instruction is sent to the outside. Based on the correction instruction, the display data of the gas meter is corrected and compensated.

4. The optimization of the gas meter data is implemented, the interference caused by temperature and pressure is eliminated to a certain extent, and the error between the data and the real data is less, and the authenticity and reliability of the display data of the gas meter are improved. The economic loss incurred is relatively small by taking it as a valuation standard; by constructing the compensation model, the number of times of continuous data optimization can be reduced and the optimization efficiency can be improved.

5. By constructing the gas meter optimization knowledge graph, according to the fluid features, the gas meter matches the corresponding optimization plan from the gas meter optimization knowledge graph to perform targeted optimization of the gas meter, so that the optimized gas meter better fits the measurement condition in which the gas meter is. When an abnormality occurs in the gas meter, it can be processed quickly and frequently to improve optimization efficiency.

### BRIEF DESCRIPTION OF DRAWINGS

FIG. 1 is a schematic flow chart of an optimization method for measurement data of an ultrasonic gas meter according to the present disclosure; and

FIG. 2 is a schematic diagram of an optimization system result of the measurement data of the ultrasonic gas meter according to the present disclosure.

### DETAILED DESCRIPTION OF EMBODIMENTS

The technical solutions in the embodiments of the present disclosure will be clearly and completely described below with reference to the accompanying drawings in the embodiments of the present disclosure. Apparently, the described embodiments are only some of the embodiments of the present disclosure, rather than all the embodiments. Based on the embodiments of the present disclosure, all other embodiments obtained by those of ordinary skill in the art without making creative efforts fall within the scope of protection of the present disclosure.

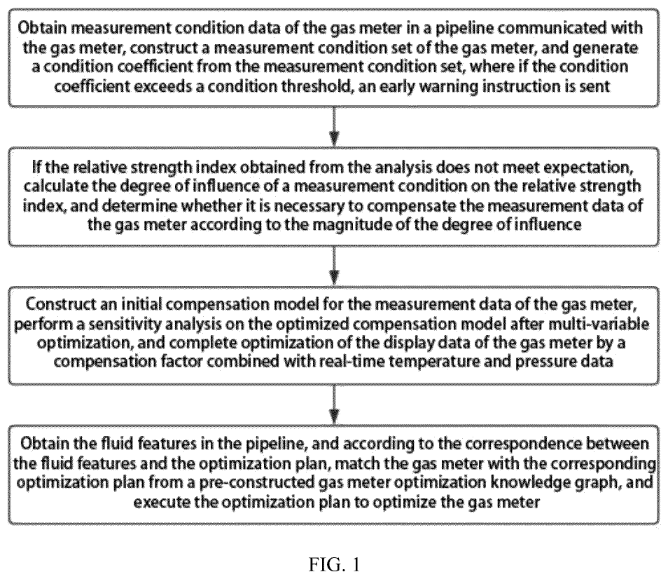

Referring to FIG. 1, the present disclosure provides an optimization method based on measurement data of an ultrasonic gas meter, which includes the following steps:

Step 1: Measurement condition data of the gas meter in a pipeline communicated with the gas meter is obtained, a measurement condition set of the gas meter is constructed, and a condition coefficient Wp(t,u) is generated from the measurement condition set, where if the condition coefficient Wp(t,u) exceeds a condition threshold, an early warning instruction is sent;

Step 1 includes the following:
Step 101: After the position of the gas meter is determined, a monitoring point is set up in the pipeline connected thereto, and the corresponding monitoring cycle is determined, such as 1 minute or 3 minutes. In each monitoring cycle, the temperature and pressure in the pipeline are measured to respectively obtain the measured temperature c: and the measured pressure cu of the gas meter, that is, the ultrasonic gas meter when it works; after several consecutive monitoring cycles, the data obtained by monitoring is summarized to construct a measurement condition set for the gas meter;
Step 102: The condition coefficient Wp(t,u) is generated from the measurement condition set, where the condition coefficient Wp(t,u) is obtained as follows: linear normalization is performed on the measured temperature Ct and the measured pressure Cu, and the corresponding data values are mapped within the interval [0,1], and then based on the following formula:

$$Wp ( t , u ) = α * \frac{C {t}_{i} ( n - 1 )}{{\sum }_{i = 1}^{n} {( C {t}_{i} - \overline{Ct} )}^{2}} + β * \frac{C {u}_{i} ( n - 1 )}{{\sum }_{i = 1}^{n} {( C {u}_{i} - \overline{Cu} )}^{2}}$$

where C̅t̅ is an average value of the measured temperature in each monitoring cycle, and C̅u̅ is an average value of the measured pressure in the monitoring cycle; weight coefficients are as follows: 0≤β≤1, 0≤α≤1, and α+β=1, the weight coefficients can be obtained by referring to an analytic hierarchy process;
where i=1, 2, . . . , n, is the number in the monitoring cycle, which is a positive integer greater than 1, Ctᵢ is a value of the measured temperature at a i position, and Cuᵢ is a value of the measured pressure at the i position;
Combining historical data and management expectations for the quality of the gas meter, a condition threshold is set in advance. If the condition coefficient Wp(t,u) exceeds the preset condition threshold, it means that there may be certain abnormalities in the temperature and pressure of the gas in the pipeline. In this case, when the gas meter is used to monitor the use state of gas, there may be a certain difference between the actual data and the measured data, and the authenticity and reliability are insufficient. In this case, an early warning instruction is sent to the outside;

Additional explanations are needed as follows:

The ultrasonic gas meter calculates the flow rate and the flow by measuring the difference in propagation time of ultrasonic signals in a gas medium. Temperature and pressure are the two main environmental factors that affect the measurement accuracy of the ultrasonic gas meter. They interfere with the propagation properties of ultrasonic waves by changing the physical properties of the gas.

The sound speed of gas changes with temperature. As the temperature increases, the molecular motion speeds up and the sound speed increases; on the contrary, when the temperature decreases, the speed of sound slows down, and the temperature also affects the density of the gas. According to the ideal gas law, when the temperature increases, the volume of the gas will expand and the density will decrease without changing the pressure; as the temperature decreases, the density increases. Changing the gas density will indirectly affect the ultrasonic measurement, because the measurement of the propagation time of the sound waves usually assumes that the gas density is constant.

The density of gas changes with pressure. As the pressure increases, the gas molecules are compressed and the density increases; as the pressure decreases, the density decreases. The pressure affects the sound speed, but this effect is generally smaller in gases because gases are more compressible than liquids. However, at high pressures, the effect of pressure on the sound speed becomes more significant.

During use, the contents in Steps 101 and 102 are combined:

When the ultrasonic gas meter is in the use state, temperature and pressure factors will have a certain impact on the fluid state in the pipeline, which will ultimately cause certain interference to the measurement data of the gas meter, causing a certain error between the actual data and the display data, and if it cannot be processed in time, it will cause certain economic losses; in this step, by constructing the condition coefficient Wp(t,u), a preliminary judgment is made on the degree of interference suffered by the gas meter based on the condition coefficient Wp(t,u) If the degree of interference is large, the authenticity of the display data of the gas meter is low. In this case, timely processing is required, otherwise, the state can be continuously maintained; therefore, through the change of condition coefficient Wp(t,u) the working state of the gas meter can be predicted.

In the existing optimization methods for measurement data, when the ultrasonic gas meter continuously outputs display data to the outside, the data quality is usually used as the starting point for optimization. When the output display data is abnormal, the abnormal data is replaced or corrected to finally obtain the corrected display data. However, although this method of optimizing data can reduce the frequency of abnormal data, its actual coverage is narrow, and it can only filter out several abnormal points. When there are many abnormal points, it is usually solved by alarming. Moreover, when the temperature and the pressure of the ultrasonic gas meter change, the gas state in the pipeline will also be affected. The temperature and air pressure changes will not cause enough interference to the display data of the gas meter, and the interfered display data will be difficultly determined as the abnormal data, which, thus, makes it difficult for existing optimization methods to play a practical role.

Step 2: Upon receiving the early warning instruction, a trend analysis is performed on the display error of the gas meter. If the relative strength index obtained from the analysis does not meet expectation, the degree of influence of a measurement condition on the relative strength index is calculated, and whether it is necessary to compensate the measurement data of the gas meter is determined according to the magnitude of the degree of influence;

The Step 2 includes the following content:

Step 201: At the monitoring point in the pipeline, the actual gas consumption in each monitoring cycle is monitored to obtain the measurement data, and an error set is constructed after several display errors are obtained continuously by taking a difference between the measurement data and the display data of the gas meter as the display error; a trend analysis is performed on the display errors within the error set, corresponding relative strength indexes are obtained, and whether the relative strength index within the current monitoring cycle falls within a preset interval is determined, if not, a judgment instruction is sent;

Where the relative strength index is obtained as follows:

The display error change (amounts of increase and decrease) in each monitoring cycle is calculated, that is, the display error in the current monitoring cycle is subtracted from the display error in the previous monitoring cycle; the positive display error changes (amount of increase) and negative display error changes (amount of decrease) are accumulated separately, and the relative strength (RS) is calculated. By calculating the proportion of RS, the relative strength index (RSI) is obtained.

Through the trend analysis, the relative strength index is used to analyze the change degree of the display error, so that whether the errors generated by the gas meter will accumulate after long-term use is judged, and according to the judgment result, whether it is necessary to overhaul the gas meter is determined. If the maintenance standard is met, the use of the gas meter can be suspended and the gas meter enters a maintenance state.

Step 202: Upon receiving the judgment instruction, the relative strength index and the corresponding condition coefficient Wp(t,u) in multiple monitoring cycles are continuously obtained, and linear regression analysis is performed by taking the measurement condition data corresponding to the condition coefficient Wp(t, u) as an independent variable and the relative strength index in each monitoring cycle as a dependent variable, and the corresponding regression equation is obtained.

Step 203: A regression coefficient corresponding to the measurement condition data in the regression equation is taken as an influence factor, and then an influence coefficient Yr(t,u) is constructed as follows:

$$\{ \begin{matrix}Yr ( t , u ) = {\partial }_{1}^{t} * {ψ}_{1} + {\partial }_{2}^{u} * {ψ}_{2} \\ {ψ}_{1} + {ψ}_{2} = 1\end{matrix}$$

Where ∂₁^{t} is the influence factor of the measured temperature Ct, ∂₂^{u} is the influence factor of the measured pressure Cu; weight coefficients are as follows: 0≤ψ1≤1, 0≤ψ2≤1; and the weight coefficient can be obtained by referring to an analytic hierarchy process;
Combining historical data and use expectations of the gas meter, an influence threshold is set in advance. If the influence coefficient Yr(t,u) exceeds the influence threshold, it means that the influence of the two representative conditions of temperature and pressure in the pipeline on the display error of the gas meter is cumulative, if it cannot be handled in time, the gas meter may be damaged. In this case, a correction instruction is sent to the outside;
If the influence coefficient Yr(t,u) does not exceed expectation, it means that the influence on the operation of the gas meter is stable, and a reminder instruction is issued at this time.

The trend analysis can refer to the following content:

Trend analysis is a statistical method used to detect the movement direction or path of a series of data points (such as time sequence data) within a certain period of time. It predicts future trends by analyzing historical data, helps understand past behaviors, and attempts to predict changes which may occur in the future. Trend analysis is widely used in financial analysis, meteorology, market research, and various scientific researches.

Relative strength index is an indicator commonly used in trend analysis to measure the strength or direction of a trend. It refers to a measure of how much a particular variable changes over time.

During use, the contents in Steps 201 to 203 are combined as follows:

After multiple regression analysis, the influence coefficient Yr(t,u) constructed, and the degree of influence of the measurement condition of the gas meter on its display error change trend is judged according to the value of the influence coefficient Yr(t,u) If the degree of influence is large, a correction instruction is sent to the outside. Based on the correction instruction, the display data of the gas meter are corrected and compensated; moreover, after several different regression analyses, factors other than temperature and air pressure can also be judged and analyzed.

Step 3: An initial compensation model for the measurement data of the gas meter is constructed. After multi-variable optimization, a sensitivity analysis is performed on the optimized compensation model. The corresponding compensation factors are determined according to the analysis result. The compensation factors are combined with real-time temperature and pressure data to complete the optimization of the display data of the gas meter;

Step 3 includes the following:

Step 301: the gas flows at different temperatures and pressures are measured to complete data collection; according to the gas state equation, the influence of temperature and pressure on the density of gas is analyzed, the degree of influence of the propagation speed of ultrasonic waves in gas by temperature and pressure is determined, and the corresponding physical connection is obtained;

According to the collected data and physical connections, an initial compensation model is constructed based on an empirical nonlinear equation to describe the influence of temperature and pressure on the measurement data, thereby completing the construction of the initial compensation model:

Step 302: Standard test data is obtained. For example, standard gas with known parameters (such as temperature, pressure, and flow) is used to conduct experiments, the temperature and pressure conditions are changed, and the corresponding measurement data is recorded to obtain test data; optimize the model parameters of the initial compensation model are optimized by using multiple linear regression analysis, so that the values predicted by the model fit the test data, and other variables, such as gas type and humidity are used to perform multi-variable optimization and verification of the initial compensation model to obtain the optimized compensation model;

Step 303: A sensitivity analysis is performed on the optimized compensation model. The degree of influence of the analysis factors on the measurement data is obtained by using temperature and pressure as analysis factors. The corresponding compensation factor is determined based on the degree of influence. The compensation factor is combined with the real-time temperature and pressure data to dynamically adjust the display data of the gas meter.

During use, the contents in Steps 301 to 303 are combined as follows:

Upon receiving the correction command, a compensation model is constructed, and the corresponding compensation factor is obtained after sensitivity analysis. Therefore, according to the compensation factor and the current temperature and pressure data, the current display data of the gas meter is compensated and corrected. After correction and compensation, the gas meter data is optimized; therefore, the optimized display data of the gas meter eliminates the interference caused by temperature and pressure to a certain extent, and the error between the data and the real data is less, and the authenticity and reliability of the display data of the gas meter are improved. The economic loss incurred is relatively small by taking it as a valuation standard; by constructing the compensation model, the number of times of continuous data optimization can be reduced and the optimization efficiency can be improved.

Step 4: If the corrected display data of the gas meter is not as accurate as expected, the fluid features in the pipeline are obtained, and according to the correspondence between the fluid features and the optimization plan, the gas meter matches with the corresponding optimization plan from a pre-constructed gas meter optimization knowledge graph, and the optimization plan is executed to optimize the gas meter,

Step 4 includes the following:

Step 401: A data accuracy model is constructed by taking the measured data as the display data of the gas meter to respectively calculate the data accuracy of the display data of the gas meter before and after correction, with reference to the following way:

$$Py = \frac{1}{3} * max \vert {Yo}_{i} - \overline{Yo} \vert + \frac{2}{3} * \sqrt[3]{\frac{1}{n} * {\sum }_{i = 1}^{n - 1} {\vert {Yo}_{i} - \overline{Yo} \vert}^{3}}$$

Where Yoᵢ is a value of the display data of the gas meter at a position i, and Y̅o̅ is an average value of the display data of the gas meter;
By taking the ratio of the data accuracy Py before and after compensation as an accuracy ratio Pb, combined with the historical data and the management expectation of the gas meter accuracy, the proportion threshold is set in advance. If the accuracy ratio Pb exceeds the proportion threshold, it means that after the measurement data of the gas meter is compensated and corrected, the data accuracy of use thereof is insufficient, and the gas meter may have certain operating faults. In this case, a self-inspection instruction is sent to the outside;
Step 402: Upon receiving the self-inspection instruction, corresponding fluid data in the pipeline is collected, such as pressure, flow rate, density, and temperature, and a fluid data set is constructed according to the fluid data and its distribution state after the data is summarized. After the characteristic standard is set, feature identification is performed on the data in the fluid data set to obtain the corresponding fluid features;
Step 403: By taking ultrasonic gas meter optimization as a target word, and a gas meter optimization knowledge graph is constructed, where a specific mode can refer to the following:
By taking ultrasonic gas meter optimization as the target word, relevant data sets, which may include literatures, reports, news, and databases are collected; the collected data is cleaned to eliminate irrelevant information, and the data is standardized; and for the cleaned data text, the data text is segmented into words by using natural language processing methods and keywords and phrases are extracted;
A deep learning model, such as a Bert-based NER model is used to identify key entities in data text, such as an environmental condition, an operating state, fluid features and optimization plans of the ultrasonic gas meter; and after the above data is summarized, a knowledge graph data set is constructed;
A relationship extraction model is used to determine the relationship between entities within the knowledge graph data set, the same or similar entities in the knowledge graph are merged, and logical inference models or machine learning models are used to discover implicit knowledge relationships; a RDF data model is used to transform data into a knowledge graph representation, including identifying core entities, defining relationships and attributes between entities, and using a unified representation;
An initial knowledge graph is constructed, including: entity nodes in the graph and the relationship edges therebetween are constructed, a graph database or graph storage system is selected, and data is loaded thereinto; on the basis of verification and evaluation, the initial knowledge map is iterated and optimized to expand the scope and depth of the map and increase the richness and accuracy of the data;
The trained and optimized initial knowledge graph is obtained and is used as the gas meter optimization knowledge graph. According to the correspondence between the fluid features and the optimization plan, the gas meter matches with the corresponding optimization plan from a pre-constructed gas meter optimization knowledge graph, and the optimization plan is executed to optimize the gas meter.

During use, the contents in steps 401 to 403 are combined as follows:

By detecting and identifying the fluid features in the pipeline, and further constructing the gas meter optimization knowledge graph, when it is needed to self-check the current operating state of the gas meter upon receiving a self-check instruction, according to the fluid features, the corresponding optimization plan is matched in the optimization knowledge graph. Therefore, according to the matched optimization plan, the gas meter can be optimized in a targeted manner, so that the optimized gas meter further fits the measurement condition where it is located; moreover, by quickly matching the optimization plan, when an abnormality occurs in the gas meter, it can be quickly and frequently handled, thereby shortening the duration of the gas meter being unusable or in poor condition, and improving the optimization efficiency.

It should be noted the analytic hierarchy process is a qualitative and quantitative analysis method that can decompose complex problems into multiple levels. By comparing the importance of factors at each level, it can help decision-makers make decisions on complex issues and determine the final decision plans, and in this process, the analytic hierarchy process can be used to determine the weight coefficients of these indicators; the analytic hierarchy process include the following steps:
Clarifying the question: First, a decision-making problem needs to be clarified, and a goal and alternatives of the decision-making need to be determined;
Constructing a hierarchical model: The problem is decomposed into different levels according to the property of the problem and the decision-making goal, usually including a target layer, a criterion layer and a program layer, where the goal layer is the overall goal of the decision-making problem, the criterion layer is a criterion used to evaluate the alternatives, and the program layer is the alternatives;
Constructing a judgment matrix: A judgment matrix is constructed by pairwise comparing the importance of elements in the same level relative to an element in the previous level. The elements in the judgment matrix represent the ratio of the relative importance of the two elements;
Single hierarchical ranking: According to the judgment matrix, the relative importance ranking weight of the elements in the same level relative to the element in the previous level is calculated. This process is called single hierarchical arrangement;
Consistency check: The consistency of the judgment matrix is tested, that is, whether the judgment matrix meets the consistency condition is tested. If the consistency condition is met, the single hierarchical ranking result is considered reasonable;
Overall hierarchical ranking: The combined weight of elements at each layer is calculated to the system goal and overall ranking is performed to determine the overall ranking weight of each element at the lowest level in the hierarchical structure diagram;
Through the analytic hierarchy process, decision makers can decompose complex decision-making problems into different levels and make decisions based on qualitative and quantitative analysis; this method can improve the accuracy and effectiveness of decision-making, and is especially suitable for complex problems that are difficult to solve using quantitative methods.

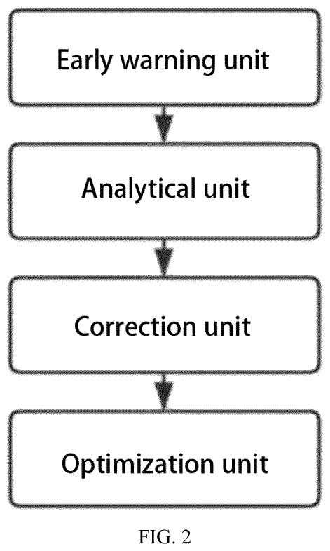

Referring to FIG. 2, the present disclosure provides an optimization system based on measurement data of an ultrasonic gas meter, including:

An early warning unit, configured to obtain measurement condition data of the gas meter in a pipeline communicated with the gas meter, construct a measurement condition set of the gas meter, and generate a condition coefficient from the measurement condition set, where if the condition coefficient exceeds a condition threshold, an early warning instruction is sent;

An analytical unit, configured to, if the relative strength index obtained from the analysis does not meet expectation, calculate the degree of influence of a measurement condition on the relative strength index, and determine whether it is necessary to compensate the measurement data of the gas meter according to the magnitude of the degree of influence;

A correction unit is configured to construct an initial compensation model for the measurement data of the gas meter perform a sensitivity analysis on the optimized compensation model after multi-variable optimization, and complete optimization of the display data of the gas meter by a compensation factor combined with real-time temperature and pressure data; and

An optimization unit is configured to obtain the fluid features in the pipeline, match the gas meter with the corresponding optimization plan from a pre-constructed gas meter optimization knowledge graph according to the correspondence between the fluid features and the optimization plan, and execute the optimization plan to optimize the gas meter.

The above embodiments may be implemented in whole or in part by software, hardware, firmware, or any other combination. When implemented using software, the above embodiments may be implemented in whole or in part in the form of a computer program product. The computer program product includes one or more computer instructions or computer programs. When the computer instructions or computer programs are loaded or executed on the computer, the processes or functions described in the embodiments of the present application are generated in whole or in part. The computer may be a general-purpose computer, a special-purpose computer, a computer network, or other programmable devices. The computer instructions may be stored in a computer-readable storage medium or transmitted from one computer-readable storage medium to another, e.g., the computer instructions may be transferred from a website, computer, server, or data center to another website, computer, server or data center by wired (such as infrared, wireless, and microwave) means. The computer-readable storage medium may be any available medium that can be accessed by a computer, or a data storage device such as a server or a data center that contains one or more sets of available media. The usable media may be magnetic media (e.g., floppy disk, hard disk, tape), optical media (e.g., DVD), or semiconductor media. The semiconductor medium may be a solid state drive.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled artisans may implement the described functionality using different methods for each specific application, but such implementations should not be considered beyond the scope of this application.

Those skilled in the art can clearly understand that for the convenience and simplicity of description, the specific working processes of the systems, devices and units described above can be referred to the corresponding processes in the foregoing method embodiments, and will not be described again here.

In the several embodiments provided in this application, it should be understood that the disclosed systems, devices, and methods can be implemented in other ways. For example, the device embodiments described above are only illustrative. For example, the division of the units is only for some logical functions. In actual implementation, there may be other division methods. For example, multiple units or components may be combined or may be integrated into another system, or some features can be ignored, or not implemented. On the other hand, the coupling or direct coupling or communication connection between each other shown or discussed may be through some interfaces, and the indirect coupling or communication connection of the devices or units may be in electrical, mechanical or other forms.

The units described as separate components may or may not be physically separated, and the components shown as units may or may not be physical units, that is, they may be located in one place, or they may be distributed to multiple network units. Some or all of the units can be selected according to actual needs to achieve the purpose of the solution of this embodiment.

In addition, each functional unit in each embodiment of the present application can be integrated into one processing unit, each unit can exist physically alone, or two or more units can be integrated into one unit.

If the functions are implemented in the form of software functional units and sold or used as independent products, they can be stored in a computer-readable storage medium. Based on this understanding, the technical solution of the present application is essentially or contributes to the existing technology or the part of the technical solution can be embodied in the form of a software product. The computer software product is stored in a storage medium, including Several instructions are used to cause a computer device (which can be a personal computer, a server, or a network device, etc.) to execute all or part of the steps of the methods described in various embodiments of this application. The aforementioned storage media include: a U disk, a mobile hard disk, a read-only memory (ROM), a random access memory (RAM), a magnetic disk or an optical disk and other media that can store program code.

The above are only specific embodiments of the present application, but the protection scope of the present application is not limited thereto. Any person familiar with the art can easily think of changes or substitutions within the technical scope disclosed in the present application, which should be covered by the protection scope of this application. Therefore, the protection scope of this application should be subject to the protection scope of the claims.

The above are only specific embodiments of the present application, but the protection scope of the present application is not limited thereto. Any person familiar with the art can easily think of changes or substitutions within the technical scope disclosed in the present application, which should be covered by the protection scope of this application.

1. An optimization method based on measurement data of an ultrasonic gas meter, comprising causing a computer to execute computer instructions stored on a computer-readable storage medium, wherein the computer instructions comprise steps of:
obtaining measurement condition data of the gas meter in a pipeline communicated with the gas meter, constructing a measurement condition set of the gas meter, and generating a condition coefficient Wp(t, u) from the measurement condition set, wherein if the condition coefficient Wp(t,u) exceeds a condition threshold, an early warning instruction is sent;
wherein the temperature and pressure in the pipeline are monitored in each monitoring cycle to respectively obtain a measured temperature Ct and a measured pressure Cu when the gas meter works; after several consecutive monitoring cycles, the data obtained by monitoring is summarized to construct the measurement condition set of the gas meter;
the condition coefficient Wp(t, u) is obtained as follows: linearly normalizing the measured temperature Ct and the measured pressure Cu, and mapping the corresponding data values in an interval [0, 1], and then based on the following formula:
$$Wp ( t , u ) = α * \frac{C {t}_{i} ( n - 1 )}{{\sum }_{i = 1}^{n} {( C {t}_{i} - \overline{Ct} )}^{2}} + β * \frac{C {u}_{i} ( n - 1 )}{{\sum }_{i = 1}^{n} {( C {u}_{i} - \overline{Cu} )}^{2}}$$
where C̅t̅ is an average value of the measured temperature in each monitoring cycle, and C̅u̅is an average value of the measured pressure in the monitoring cycle; weight coefficients are as follows: 0≤β≤1, 0≤α≤1, and α+β=1, where i=1, 2, . . . n, n is the number in the monitoring cycle, which is a positive integer greater than 1, and Ctᵢ is a value of the measured temperature at a position i, and Cuᵢ is a value of the measured pressure at the position i;
upon receiving the early warning instruction, performing a trend analysis on a display error of the gas meter; if the relative strength index obtained from the analysis does not meet expectation, calculating the degree of influence of a measurement condition on the relative strength index, and determining whether it is necessary to compensate the measurement data of the gas meter according to the magnitude of the degree of influence, wherein the actual gas consumption is monitored in each monitoring cycle to obtain the measurement data, and an error set is constructed after several display errors are obtained continuously by taking a difference between the measurement data and the display data of the gas meter as the display error; performing a trend analysis on the display errors within the error set, obtaining corresponding relative strength indexes, and determining whether the relative strength index within the current monitoring cycle falls within a preset interval, if not, sending a judgment instruction;
according to the collected data and a physical connection, constructing an initial compensation model for the measurement data of the gas meter based on an empirical nonlinear equation; performing a sensitivity analysis on the optimized compensation model after multi-variable optimization, and determining corresponding compensation factors according to an analysis result; completing optimization of the display data of the gas meter by a compensation factor combined with real-time temperature and pressure data, wherein a gas flow is measured at different temperatures and pressures to complete data collection; according to a gas state equation, analyzing the influence of temperature and pressure on the density of gas, determining the degree of influence of a propagation speed of ultrasonic waves in gas by temperature and pressure, and obtaining the corresponding physical connection; and according to the collected data and the physical connection, constructing an initial compensation model based on an empirical nonlinear equation;
obtaining standard test data, optimizing model parameters of the initial compensation model by using multiple linear regression analysis to make the values predicted by the model fit test data, performing multi-variable optimization and verification of the initial compensation model by using other variables, and obtaining the optimized compensation model;
if the corrected display data of the gas meter is not as accurate as expected, obtaining the fluid features in the pipeline, matching the gas meter with the corresponding optimization plan from a pre-constructed gas meter optimization knowledge graph according to the correspondence between the fluid features and the optimization plan, and executing the optimization plan to optimize the gas meter, wherein a data accuracy model is constructed by taking the measured data as the display data of the gas meter to respectively calculate the data accuracy Py of the display data of the gas meter before and after correction, wherein:
$$Py = \frac{1}{3} * max \vert {Yo}_{i} - \overline{Yo} \vert + \frac{2}{3} * \sqrt[3]{\frac{1}{n} * {\sum }_{i = 1}^{n - 1} {\vert {Yo}_{i} - \overline{Yo} \vert}^{3}}$$
where Yoᵢ is a value of the display data of the gas meter at a position i, and Y̅o̅ is an average value of the display data of the gas meter;
by taking the ratio of the data accuracy Py before and after compensation as an accuracy ratio Pb, if the accuracy ratio Pb exceeds a proportion threshold, sending a self-inspection instruction to the outside; and
upon receiving the self-inspection instruction, collecting corresponding fluid data in the pipeline, according to the fluid data and its distribution status, constructing a fluid data set after summarizing the fluid data, after setting a feature standard, performing feature identification on the data in the fluid data set to obtain corresponding fluid features; and constructing and obtaining an initial knowledge graph after training and optimization and using the same as a gas meter optimization knowledge graph by taking ultrasonic gas meter optimization as a target word.

2. The optimization method based on measurement data of an ultrasonic gas meter according to claim 1, wherein upon receiving the judgment instruction, the relative strength indexes and the corresponding condition coefficient Wp(t, u) in multiple monitoring cycles are continuously obtained, and linear regression analysis is performed by taking the measurement condition data corresponding to the condition coefficient Wp(t, u) as an independent variable and the relative strength index in each monitoring cycle as a dependent variable, and the corresponding regression equation is obtained.

3. The optimization method based on measurement data of an ultrasonic gas meter according to claim 2, wherein:
a regression coefficient corresponding to the measurement condition data in the regression equation is taken as an influence factor, and then an influence coefficient Yr(t, u) is constructed as follows:
$$\{ \begin{matrix}Yr ( t , u ) = {\partial }_{1}^{t} * {ψ}_{1} + {\partial }_{2}^{u} * {ψ}_{2} \\ {ψ}_{1} + {ψ}_{2} = 1\end{matrix}$$
where ∂ₜ¹ is the influence factor of the measured temperature C̅t̅, ∂₂^{u} is the influence factor of the measured pressure Cu; weight coefficients are as follows: 0≤ψ1≤1, 0≤ψ2≤1; if the influence coefficient Yr(t, u) exceeds an influence threshold, a correction instruction is sent to the outside; and if the influence coefficient Yr(t, u) does not exceed expectation, a reminder instruction is sent.
